(19) United States
(12) Patent Application Publication
(10) Pub. No.: US 2009/0317050 A1
(43) Pub. Date: Dec. 24, 2009

(54) SYSTEM FOR PROVIDING THE INTERACTIVE MOVING PICTURE CONTENTS AND THE METHOD THEREOF

(76) Inventors: Dong Soo Son, Seoul (KR); Gun Yeun Kim, Seoul (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/373,685

(22) PCT Filed: Jul. 12, 2007
(86) PCT No.: PCT/KR07/03381

§ 371 Date: Jan. 14, 2009

(30) Foreign Application Priority Data
Jul. 14, 2006 (KR) 10-2007-66359
Jul. 9, 2007 (KR) 10-2006-68792

(51) Int. Cl. H04N 5/93; G06F 17/30

(52) U.S. Cl. 386/52; 707/3

(57) ABSTRACT

The present invention relates to a system and method for providing interactive moving picture contents, and more particularly, to a system and method for providing moving picture contents, wherein moving picture contents provided by a user are divided into an original moving picture and additional contents to be stored separately, so that if another user makes a request for using one of previously registered moving picture contents, respective layers created from an original moving picture and additional contents of the relevant moving picture contents are combined and provided to the other user, and at the same time, a function of editing the additional contents for the relevant moving picture is provided to allow users of the moving picture contents other than a user who has initially provided the moving picture contents to easily modify the additional contents or add a variety of additional contents related to the original moving picture.

### TECHNICAL FIELD

The present invention relates to a system and method for providing interactive moving picture contents, and more particularly, to a system and method for providing moving picture contents, wherein moving picture contents provided by a user are divided into an original moving picture and additional contents and the divided original moving picture and additional contents are separately stored, so that if another user makes a request for using one of previously registered moving picture contents, respective layers created from an original moving picture and additional contents of the relevant moving picture contents are combined and provided to the other user, and at the same time, a function of editing the additional contents for the relevant moving picture is provided to allow users of the moving picture contents other than a user who has initially provided the moving picture contents to easily modify the additional contents or add a variety of additional contents related to the original moving picture.

### BACKGROUND ART

Recently, the Internet and computers are widely used in the fields of economy, industry, and education due to popularization of the Internet and computers. A computer user can access an information-providing server system through the Internet to search for information and can obtain desired information from the server system, so that the user can easily search for and obtain desired information through the Internet and a computer using such a technique.

With the development of techniques related to media and the Internet, methods of implementing contents for use in configuring web-pages where a variety of moving pictures are implemented are currently developed and used. Accordingly, information is provided through contents that are configured in a form including dynamic images, i.e., moving pictures, other than a static image form, thereby improving interests and satisfactions of computer users.

Services for providing moving picture contents through the Internet as described above are increasingly utilized in the fields of electronic commerce, entertainment, remote education, and the like. Accordingly, a variety of methods of providing desired contents information in each of the application fields are being developed.

In a conventional method of providing moving picture contents on the Internet, for example, as shown in FIG. 1, when a user views a moving picture for promoting a movie provided at a movie promotion site on the Internet and then clicks movie information or an official homepage menu with a mouse to view additional information related to the moving picture, a relevant webpage is separately created to provide relevant information. However, since such a contents-providing method provides moving picture contents through a process of re-combining a base moving picture with desired information (subtitle, image, and the like), a need for a modification or addition operation to a moving picture to be serviced, which has been finally produced, results in quite a large amount of additional production cost. Thus, there is limitation on reuse of the moving picture contents in other exposure media (TV, cable broadcasting, wired and wireless networks, theaters, and the like).

Further, in a conventional method of providing moving picture contents through a network, selected moving picture contents are merely shown one-sidedly through a basic player with the passage of time, and thus, there is limitation on user's actions for actively inquiring or searching for information related to a specific scene while a user views a moving picture. Furthermore, since information on a moving picture, information on a related product and information on an event are exposed at positions different from that of the moving picture, user's views are decentralized and the user's concentration thereon is lowered. Therefore, there is a problem in that the efficiency of advertisement, promotion, and additional services is lowered.

Furthermore, when a user wants to add a variety of information to provided moving picture contents by himself/herself and to reuse the moving picture contents for personal or commercial purposes, the user has difficulty in using an image editing tool that is hard to operate. Further, there is a limitation in that problems related to copyrights may occur in a process of modifying and reusing an original moving picture.

That is, a conventional moving picture contents providing service merely provides one-sided playback of a moving picture selected by a user and simple additional functions such as simple bookmarking and subtitle processing, and has a problem in that since a user is difficult to modify and reuse a moving picture by himself/herself in the service, the service does not meet a user created contents (UCC) environment that is widely used recently.

### DISCLOSURE

### Technical Problem

The present invention is conceived to solve the aforementioned problems of the conventional moving picture contents providing service. Accordingly, an object of the present invention is to provide a system and method for providing moving picture contents, wherein moving picture contents provided by a user are divided into an original moving picture and additional contents and the divided original moving picture and additional contents are separately stored, so that if another user makes a request for using one of previously registered moving picture contents, respective layers created from an original moving picture and additional contents of the relevant moving picture contents are combined and provided to the other user, thereby effectively inquiring additional contents information related to the original moving picture on a moving picture screen while the moving picture contents are viewed.

In addition, another object of the present invention is to provide a function of conveniently editing additional contents of moving picture contents rather than an original moving picture of the moving picture contents, thereby avoiding a possibility of infringement on a copyright, which may be involved in modification of the original moving picture, and adding a variety of additional information to the existing moving picture contents without inconvenience of using an image editing tool and reusing the contents with the additional information added thereto.

### Technical Solution

The present invention based on a technical spirit for achieving the object provides a system for providing interactive moving picture contents, comprising: an input tool for inputting and editing moving picture contents; a moving picture contents server for providing a user with moving picture contents containing original moving picture data and related additional contents so that the user can view and edit the moving picture contents; and a player for synthesizing a moving picture from an original moving picture and additional contents information transmitted from the moving picture contents server by using moving picture contents information containing the original moving picture data and the additional contents information, and for outputting the synthesized moving picture on a screen, wherein the moving picture contents server comprises a database unit for storing membership information, moving picture information, and related additional contents information; a data management unit for managing the database unit; a contents transmitting/receiving unit for transmitting and receiving the moving picture contents information to and from the input tool and the player; and a source providing unit for providing source data needed for editing the moving picture contents with the input tool.

Further, the present invention provides a method of providing interactive moving picture contents to a user's terminal from a moving picture contents server, comprising: a step of connecting, by a user, with the moving picture contents server through a terminal of the user; a moving picture contents registering step of, if the user requests registration of new contents, providing the user's terminal with a moving picture contents registration screen, and receiving and storing playback information including a title, menu, and subtitle of a relevant original moving picture, together with original moving picture data or information on a link to the original moving picture; a moving picture contents providing step of, if the user requests use of previously registered contents stored in the moving picture contents server, providing the user's terminal with moving picture contents synthesized from layers that are configured respectively with an original moving picture and related additional contents information of the requested moving picture contents; and an additional contents editing step of, if the user requests editing additional contents for the new moving picture contents registered by the user or for the previously registered contents provided to the user, providing the user's terminal with an additional contents edit screen and storing additional contents edited by the user.

### ADVANTAGEOUS EFFECTS

With the system and method for providing interactive moving picture contents according to the present invention, a user can conveniently inquire additional contents information related to a moving picture scene while using moving picture contents and simultaneously intuitively recognize image information, related product information, and event information. Thus, there are advantages in that advertisements, promotions, additional services can be efficiently provided within the moving picture contents.

Furthermore, the present invention has an advantage of implementing an interactive service, wherein a product exposed in a moving picture and related products are hierarchically provided to a user through a moving picture screen, and the user can conveniently purchase a related product in real time while viewing the moving picture.

### DESCRIPTION OF DRAWINGS

FIG. 1 is a view showing a conventional moving picture contents providing screen.

FIG. 2 is a view showing the configuration of a system for providing interactive moving picture contents according to a first embodiment of the present invention.

FIG. 3 is a view showing the configuration of a moving picture contents screen provided to a user's terminal by a contents providing unit shown in FIG. 2.

FIG. 4 is a view showing a process of outputting additional contents information corresponding to user's input upon playback of a moving picture.

FIG. 5 is a view showing the configuration of a system for providing interactive moving picture contents according to a second embodiment of the present invention.

FIG. 6 is a flowchart illustrating a method of providing interactive moving picture contents according to an embodiment of the present invention.

FIG. 7 is a flowchart illustrating detailed procedures of the step of providing moving picture contents illustrated in FIG. 6.

FIG. 8 is a flowchart illustrating detailed procedures of the step of editing additional contents illustrated in FIG. 6.

FIG. 9 is a flowchart illustrating detailed procedures of the step of inputting mask information illustrated in FIG. 8.

FIG. 10 is a view showing an example in which a moving picture contents screen is configured based on the mask information that is input according to the procedures illustrated in FIG. 9.

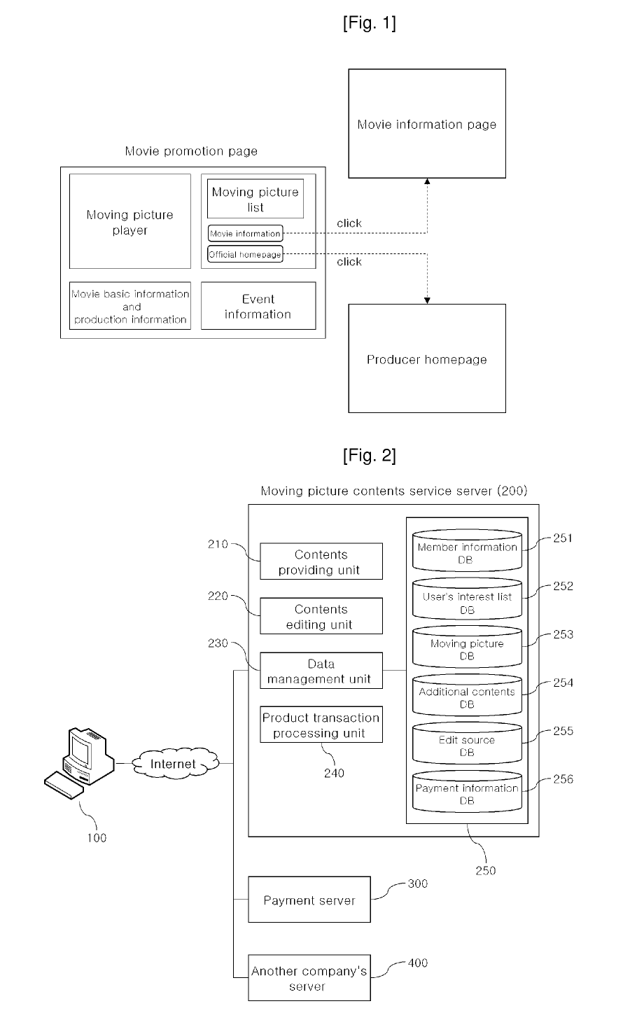

### EXPLANATION OF REFERENCE NUMERALS FOR MAIN PORTIONS IN DRAWINGS

100, 600: User's terminal
200, 700: Moving picture contents server
210: Contents providing unit
220: Contents editing unit
230, 730: Data management unit
240, 740: Product transaction processing unit
250, 750: Database unit
300: Payment server
400: Another company┌ s server
610: Input tool
620: Player
710: Contents transmitting/receiving unit
720: Source providing unit

### BEST MODE

Hereinafter, preferred embodiments of the present invention will be described in detail with reference to the accompanying drawings.

FIG. 2 is a view showing the configuration of a system for providing interactive moving picture contents according to a first embodiment of the present invention.

As shown in FIG. 2, the system for providing interactive moving picture contents according to the first embodiment of the present invention includes a user's terminal 100; a moving picture contents server 200 that is connected to the user's terminal 100 through the Internet, receives moving picture contents information composed of original moving picture data and related additional contents from a contents provider connected through the user's terminal 100, stores the received moving picture contents information, and provides requested moving picture contents of previously registered moving picture contents in response to a request from a user connected through the user's terminal 100 so that the user can view and edit the moving picture contents; and a payment server 300 that is connected to the moving picture contents server 200 and processes payment in response to a payment request from the moving picture contents server 200.

The term “moving picture contents” used herein refers to a set of information that includes original moving picture data, playback information, such as a title, subtitle and user-defined menu of a moving picture, needed for playing back the moving picture, and a variety of additional contents information related to scenes, characters, backgrounds, products and the like appearing in the moving picture. After a user connects with the moving picture contents server 200 through the user's terminal 100, the user can search moving picture contents provided by contents providers or general users, view an original moving picture of desired moving picture contents as well as a variety of additional contents information displayed in the form of an information window on the moving picture, and move to another site or view further additional contents information by clicking the information window or a menu in the information window. Respective components of the moving picture contents configured as above are implemented on separate layers, and the layers are combined into an image that in turn is displayed on the user's terminal 100. Details thereof will be described below.

The moving picture contents server 200 includes a database unit 250 for storing user's membership information, moving picture information, and a variety of additional contents information related to a moving picture; a data management unit 230 for managing the database unit 250 and searching for and reading data stored in the database unit 250; a contents providing unit 210 for providing the user's terminal 100 with moving picture contents synthesized in real time from a relevant original moving picture and additional contents information in response to a user's request; a contents editing unit 220 for providing the user's terminal 100 with a menu for editing newly or previously registered moving picture contents and causing edited moving picture contents to be stored in the database unit 250 through the data management unit 230; and a product transaction processing unit 240 for processing transactions in products contained in the additional contents.

The user's terminal 100 may be a variety of terminals, such as a personal computer (PC), a notebook computer, a cellular phone, and a personal data assistant (PDA), that have a communication function capable of connecting with the Internet in a wired or wireless manner. After a user drives a web browser by manipulating the user's terminal 100, the user connects with and logs in the moving picture contents server 200 so as to register new moving picture contents or search for previously registered moving picture contents and to use desired moving picture contents.

The database unit 250 has a member information DB 251 for storing member's basic information including a name, an identification (ID), a password, an address, and an e-mail address; user's interest list DB 252 for storing a list of moving pictures in which each member(user) is interested; a moving picture DB 253 for storing original moving picture data or information on links to original moving pictures; and an additional contents DB 254 for storing additional contents information corresponding to each of the original moving pictures stored in the moving picture DB 253. In addition, the database unit 250 further includes an editing source DB 255 for storing a variety of editing sources provided to the user's terminal 100 when moving picture contents are edited; and a payment information DB 256 for storing payment information required for transacting a relevant product in relation with product information contained in the additional contents information.

Here, the moving picture DB 253 stores an original moving picture file transmitted from the user's terminal 100 upon registration of the moving picture contents, or information on a link (Uniform Resource Locator, URL) to the original image file stored in another company┌ s server 400 as well as playback information, such as a title, subtitle and user-defined menu of a moving picture and mask information, required for playing back the moving picture. The additional contents DB 254 hierarchically stores basic additional information related to scene elements, i.e., characters, backgrounds, products, music and the like, according to respective time bands of each of the original moving pictures stored in the moving picture DB, and subordinate additional information related to the basic additional information.

Accordingly, for specific moving picture contents, the contents providing unit 210 can combine image frames in respective time bands of an original moving picture with additional contents information windows, which contain additional contents information, in real time by using an original moving picture file stored in the moving picture DB or an original moving picture file stored in another company┌ s server 400, which is connected based on moving picture file link information, and related additional contents information stored in the additional contents DB, and can provide the synthesized moving picture contents to the user's terminal 100.

Hereinafter, the configuration of a moving picture contents screen provided to the user's terminal 100 by the contents providing unit 210, and a process of outputting additional contents corresponding to user's input upon playback of a moving picture will be described.

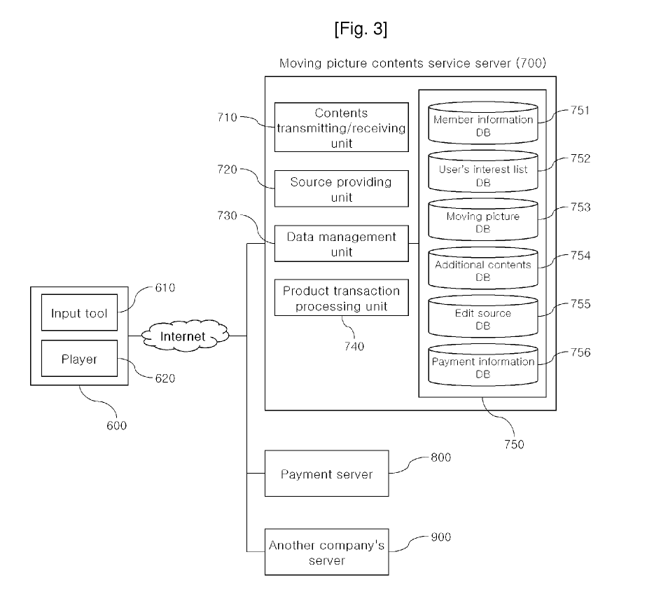

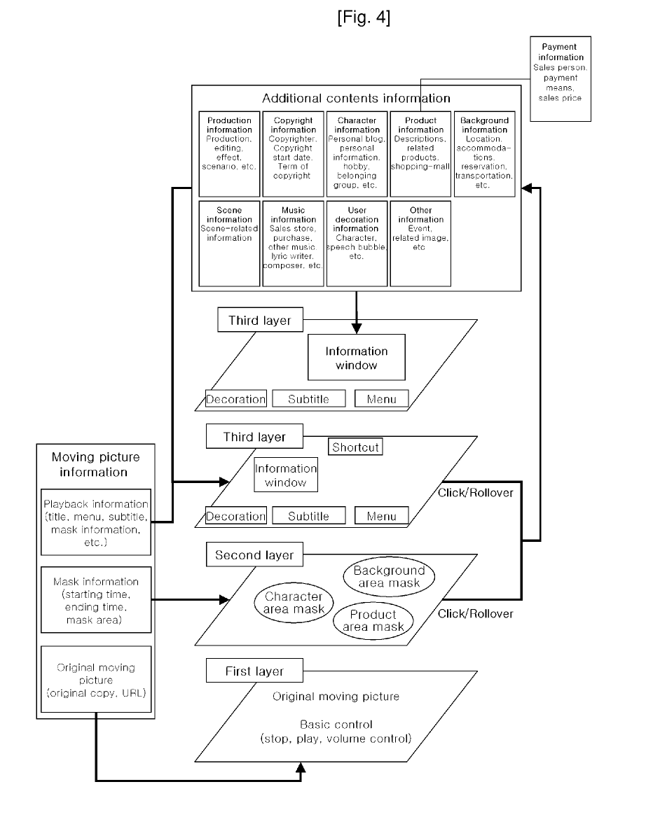

FIG. 3 is a view showing the configuration of a moving picture contents screen provided to the user's terminal by the contents providing unit shown in FIG. 2, and FIG. 4 is a view showing a process of outputting additional contents information corresponding to user's input upon playback of a moving picture.

As shown in FIG. 3, the moving picture contents screen according to the present invention is configured to display, in an overlapping manner, a first layer where an original moving picture is displayed together with a basic control menu such as stop, playback and volume control, a second layer where transparent masks representing areas of relevant scene elements, i.e., characters, backgrounds and products, of the original moving picture displayed on the first layer are created in correspondence with the relevant scene elements, and a third layer where an information window containing an edit menu, a subtitle of the moving picture, and additional contents information is arranged.

The original moving picture outputted on the first layer and the masks created on the second layer are obtained from the original moving picture information and the mask information stored in the moving picture DB. The information window arranged on the third layer may be automatically created at a predetermined position for a predetermined time period from the additional contents information or may be additionally created in response to user's input. It is preferred that the information window of the former case contain basic additional information related to scenes of respective time bands of the original moving picture among the additional contents information, and the information window of the latter case contain subordinate additional information related to the basic additional information. Here, a shortcut button linked to specific additional contents information may be arranged on the third layer, or a decoration image such as a character or speech bubble, which is set to be displayed in a relevant time band, may be outputted at a predetermined position on the third layer. A user can view a moving picture together with a variety of additional contents information on the moving picture contents screen configured as above. Furthermore, as shown in FIG. 4, if the user wants to view details related to a scene element of the moving picture or the information window displayed on the moving picture, the user utilizes a mouse to click or roll over the scene element on which the mask is imposed, or an information window or a shortcut button, so that the user can view related additional contents information through a newly created information window.

At this time, the contents providing unit 210 detects an object that the user clicks or rolls over. If the object is a transparent mask of the second layer, which is superimposed on a scene element, or an information window of the third layer, the contents providing unit searches for related additional information and causes corresponding contents to be displayed on the information window of the third layer.

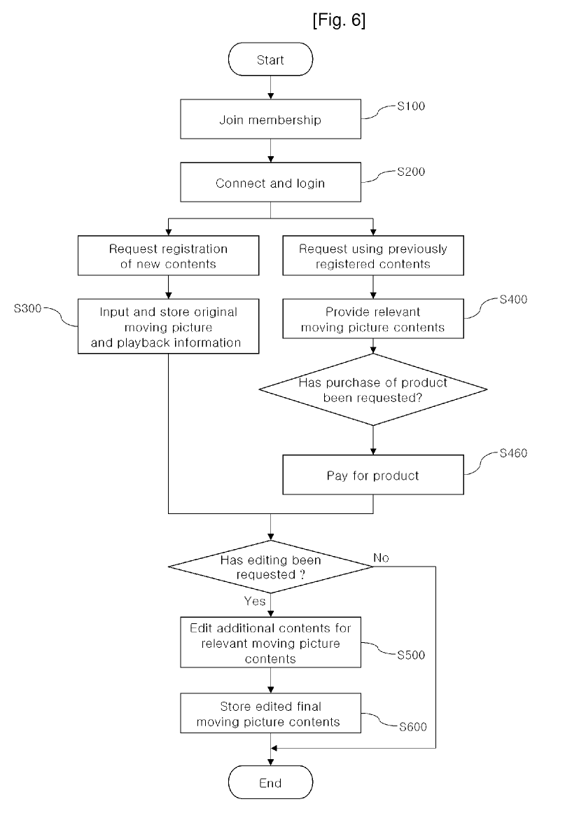

FIG. 6 is a flowchart illustrating a method of providing interactive moving picture contents according to an embodiment of the present invention. Hereinafter, the procedures of providing a moving picture contents service through the system for providing interactive moving picture contents according to the present will be described.

First, a user who connects with the moving picture contents server 200 and 700 through the user's terminal 100 and 600 joins as a member by inputting a member ID, a password and member's basic information (S100).

Next, the user connects with the moving picture contents server 200 and 700 and logs in the moving picture contents server by inputting his/her member ID and the password (S200).

Subsequently, if the user requests registration of new contents, the moving picture contents server 200 and 700 provides a moving picture contents registration screen to the user's terminal 100 and 600 and performs a moving picture contents registration process of receiving and storing playback information including a title, menu and subtitle of a corresponding original moving picture, together with original moving picture data or information on a link to the original moving picture (S300).

Here, the moving picture contents server 200 and 700 can provide the user with the moving picture contents registration screen through a web browser driven in the user's terminal 100 and 600 or an input tool installed in the user's terminal 100 and 600. The moving picture contents registration screen includes an original moving picture transmission menu, an original moving picture link address input field, a playback information input field (title of moving picture, provider/copyrighter, URL of provider/copyrighter, manager (agent or producer), URL of manager, menu, and shortcut button), and the like.

The original moving picture and playback information inputted by the user through the moving picture contents registration screen described above are transmitted to the moving picture contents server 200 and 700 and then stored in the moving picture DB of the database unit 250.

On the other hand, if the user requests the use of previously registered contents stored in the moving picture contents server 200 and 700, the moving picture contents server 200 and 700 provides the user's terminal 100 and 600 with the moving picture contents requested by the user (S400). Here, the moving picture contents server 200 and 700 combines the original moving picture of the previously registered moving picture contents with related additional contents information into a screen, outputs the synthesized screen to the user's terminal 100 and 600, and provides the additional contents information in response to user's input. Detailed procedures thereof will be described below. At this time, the moving picture contents screen synthesized from the original moving picture and the related additional contents information can be provided to the user through the web browser driven in the user's terminal 100 and 600 or a player installed in the user's terminal 100 and 600.

Next, if the user who has viewed the outputted additional contents information requests purchase of a specific product contained in the additional contents information, the moving picture contents server 200 and 700 provides a payment screen and performs a payment for the product according to a payment method desired by the user (S460).

Meanwhile, if the user requests editing of additional contents for new moving picture contents registered in the moving picture contents registration step (S300) or for previously registered moving picture contents provided in the moving picture contents providing step (S400), the moving picture contents server 200 and 700 provides the user's terminal 100 and 600 with an additional contents edit screen (S500) and stores additional contents edited by the user (S600). Here, the additional contents edit screen provided by the moving picture contents server 200 and 700 can be outputted through the web browser driven in the user's terminal 100 and 600 or the input tool installed in the user's terminal 100 and 600, in the same manner as the moving picture contents registration step.

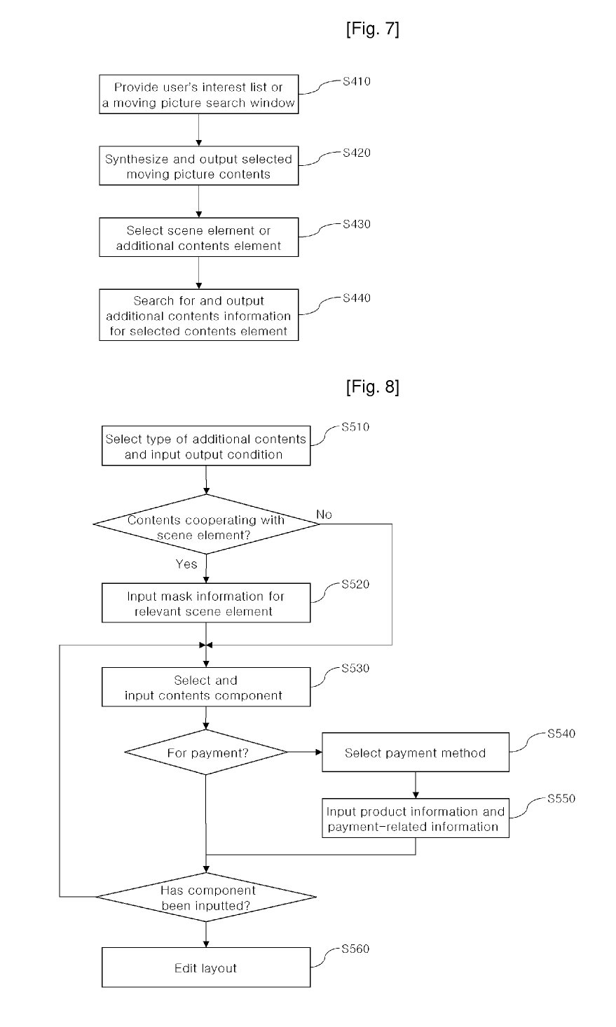

FIG. 7 is a flowchart illustrating detailed procedures of the step of providing moving picture contents illustrated in FIG. 6.

First, user's interest list or a moving picture contents search window is provided to the user's terminal 100 and 600 so as to receive a user's request for moving picture contents selected from the previously registered moving picture contents (S410). Then, the layers respectively configured with an original moving picture, mask information, and related additional contents information are combined into a series of moving picture contents screens that in turn are successively outputted to the user's terminal 100 and 600 (S420).

If the user selects one of contents elements in a time band of the outputted moving picture contents screens and requests an information search (S430), the moving picture contents server 200 and 700 searches for additional contents information of the relevant element from the database unit 250 and outputs the searched additional contents information in an information window on the moving picture contents screen (S440).

Here, the contents element in the time band of the moving picture contents screens, which is selected by the user, is a scene element such as a character, a product or a background contained in the original moving picture by a playback time band, or an information window created on the original moving picture. If the user wants to see additional information on a specific scene element or the details of the information window while viewing the original moving picture, the user can view related additional information through an additionally created information window by clicking the relevant contents element with a mouse. At this time, information on a variety of products related to the corresponding scene element is outputted in the additional contents information window, and the additional contents information window may contain a purchase request menu for a relevant product. Depending on the type of the scene element, it is possible to output a picture book of a relevant actor or clothes with the picture of an actor printed thereon if the scene element is a character, a relevant product or related products if the scene element is a product, or information on travel products if the scene element is a background of a travel site or the like. If the user wants to purchase a relevant product, the user can purchase the product on-line through the payment step (S460) by clicking the purchase request menu.

FIG. 8 is a flowchart illustrating detailed procedures of the step of editing additional contents illustrated in FIG. 6.

First, a user selects the type of additional contents to be edited and inputs an output condition of the additional contents in accordance with the type of the additional contents (S510). Here, the types of additional contents include contents automatically outputted for a specific time period, subordinate additional contents outputted by clicking superordinate additional contents with a mouse, and scene element-related contents outputted in cooperation with a relevant scene element of an original moving picture by clicking the relevant scene element. Accordingly, the user sets an output time band of the relevant additional contents if the type of additional contents is the automatically outputted contents, and sets the superordinate additional contents if the type of additional contents is the subordinate additional contents. If the type of additional contents is the scene element-related contents, input of an output condition is omitted and a scene element to be cooperated is set through the mask information input step (S520) that will be described below.

If the type of additional contents selected in step S510 is scene element-related contents to be cooperated with a scene element, the user inputs mask information corresponding to the relevant scene element through a mask information input screen that is additionally provided (S520). Here, specific procedures and a method of inputting the mask information will be described below in detail.

Next, the user selects a contents component for configuring the additional contents and inputs relevant matters (S530). Here, the types of contents components include a text, an image, a moving picture, a sound, a decoration object such as a character or a speech bubble, a purchase button, a user-defined menu, an external link, and the like.

If the inputted contents component is a purchase button, the user selects a payment method such as a mobile phone micro payment, a card payment or account transfer (S540) and inputs product information of a product for which a payment is to be made and information related to the payment (S550) through a payment attribute input screen. Here, the screen provided by the moving picture contents server 200 and 700 may be configured to input, as product information, a product category, product name, product code and the like of the product for which a payment is to be made. In this manner, it is possible to provide an environment such as a moving picture search window that allows a user who wants to use moving picture contents to search for a desired product using a product category, a product name, and a product code. Therefore, search words inputted through the moving picture search window are searched for from previously inputted product information, so that a list of moving picture contents related to the relevant product information can be promptly provided.

When the step of selecting and inputting a contents component (S530) to the step of inputting payment-related information (S550) are repeatedly performed and all components to be contained in the additional contents are completely edited, the user edits the layout of an information window in which the additional contents are outputted by adjusting the positions and sizes of the inputted components (S560).

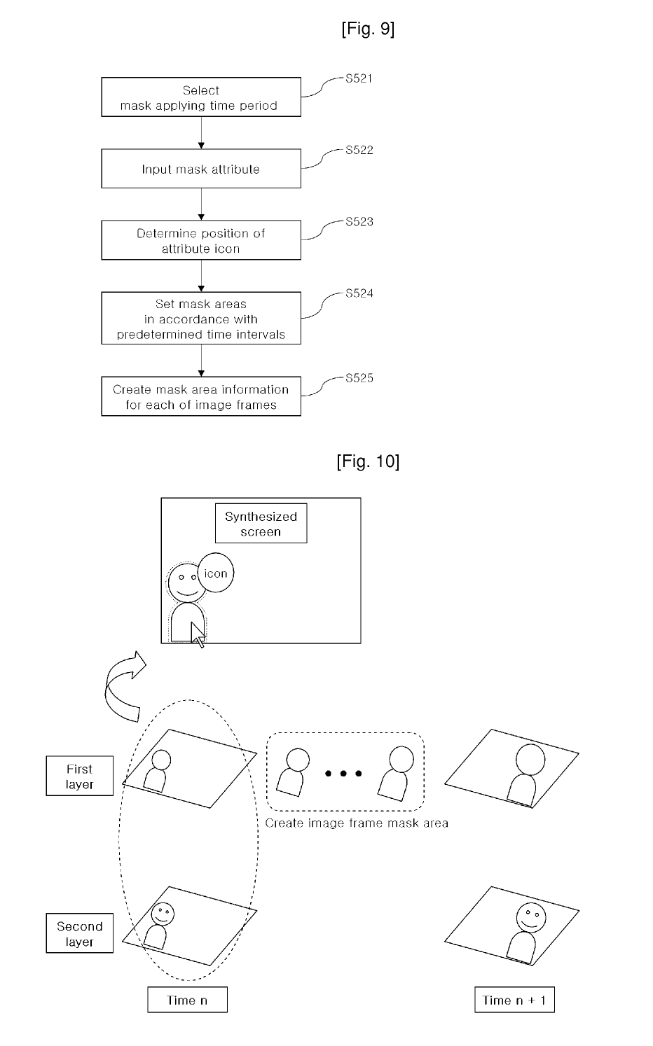

FIG. 9 is a flowchart illustrating detailed procedures of the step of inputting mask information illustrated in FIG. 8, and FIG. 10 is a view showing an example in which a moving picture contents screen is configured based on the mask information that is input according to the procedures illustrated in FIG. 9.

As shown in FIG. 9, a user inputs a time period to which a mask is applied (S521) and selects an attribute of a target scene element, i.e., any one of a character, a product, a background and music, to which the mask is applied (S522).

Here, since the mask corresponding to a scene element is transparently created on an actually outputted moving picture contents screen so that the user cannot recognize the mask, it is preferred that if the user moves the mouse cursor on an area where the mask is created, a mask attribute icon suggesting the existence of additional contents information connected with the scene element of the relevant area be outputted. To this end, the user specifies the position of the mask attribute icon, e.g., a specific position on the contour of the mask (S523).

Then, the user sets mask areas where masks are created at predetermined time intervals (S524). Here, the mask areas may be manually or automatically set. If the mask areas are automatically set, the moving picture contents server 200 and 700 performs an image analysis for image frames in respective time bands by using edge information, brightness distribution information or the like in an image so as to display minutely divided image elements on the mask information input screen and to set mask area information in a relevant time band using a combination of image elements selected by the user.

Next, the moving picture contents server 200 and 700 automatically creates mask area information for each of image frames corresponding to the entire mask application area on the basis of the inputted mask area information at predetermined time intervals (S525). Here, if a specific character appearing at a left side of an image at time n moves to a right side of the image at time n+1 after a predetermined time interval is elapsed, as shown in FIG. 10, information on the positions and sizes of the mask areas that are set in the respective time bands is used to analyze image frames corresponding to intermediate time bands between the respective time bands, thereby automatically creating mask areas. When the mask areas are completely created in this manner, an image synthesized from an original moving picture frame of the first layer and a transparent mask in a specific time band created on the second layer is outputted on the moving picture contents screen at the corresponding time band. If the user places the mouse cursor on a relevant mask area, a mask attribute icon is displayed at a predetermined position to inform the existence of additional contents information related to a scene element in the relevant area.

The present invention described above is not limited to the aforementioned embodiments and the accompanying drawings. It will be apparent to those skilled in the art that various substitutions, modifications and changes can be made thereto without departing from the technical spirit of the invention.

### MODE FOR INVENTION

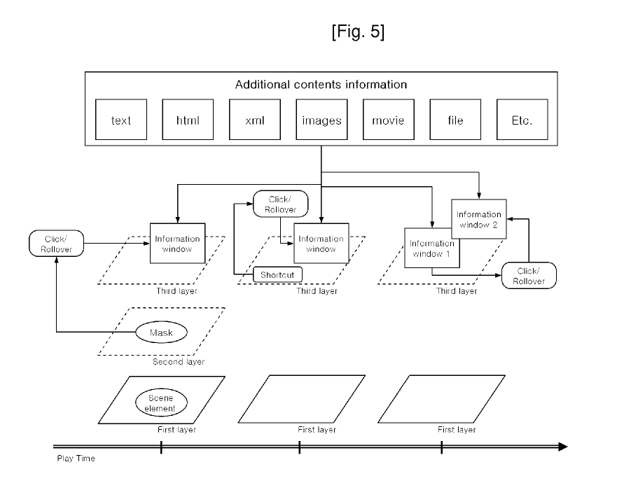

FIG. 5 is a view showing the configuration of a system for providing interactive moving picture contents according to a second embodiment of the present invention.

The system for providing interactive moving picture contents according to the second embodiment of the present invention includes an input tool 610 for inputting moving picture contents into the user's terminal 600 and editing the inputted moving picture contents; and a player 620 for combining an original moving picture with additional contents information in respective playback time bands by using moving picture contents information, which contains original moving picture data and additional contents information, transmitted from the moving picture contents server 700, and for displaying the synthesized moving picture on a screen. The moving picture contents server 700 includes a contents transmitting/receiving unit 710 for transmitting and receiving the moving picture contents information to and from the user's terminal 600, instead of the contents providing unit 210 and the contents editing unit 220 provided in the moving picture contents server 200 of the first embodiment; and a source providing unit 720 for providing source data needed when the moving picture contents are edited using the input tool of the user's terminal 100. Here, the input tool 610 and the player 620 can be downloaded from the moving picture contents server 700 and installed in the user's terminal 100 of a member who has joined the service.

As described above, the system for providing interactive moving picture contents according to this embodiment is configured such that the user's terminal performs the functions of editing and playing back moving picture contents in itself through the input tool 610 and the player 620 provided in the user's terminal 600, and the moving picture contents server 700 performs only the function of receiving information on the edited moving picture contents from the user's terminal 600 and storing the received information or transmitting stored moving picture contents information to the user's terminal 600, thereby reducing a work load on the moving picture contents server 700.

Meanwhile, since the data management unit 730, the product transaction processing unit 740, the database unit 750 and the payment server 800 of the moving picture contents server 700 are identical with those of the first embodiment, detailed descriptions thereof will be omitted.

### INDUSTRIAL APPLICABILITY

As described above, the system and method for providing interactive moving picture contents according to the present invention can implement an interactive moving picture contents service, wherein a product exposed in a moving picture and other products related thereto are hierarchically provided on a moving picture screen played back in a connected customer┌ s terminal, and a purchaser can purchase the product(s) in real time while viewing the moving picture. Thus, the system and method of the present invention can be widely applied to product advertisement of a shopping mall and a product sales company.

In addition, the present invention provides moving picture lecture contents in which private educational institutes or parents of students can easily change related educational contents to meet the level of students or the purpose of education, rather than one-sided moving picture lectures provided within limited information. Therefore, the present invention can also be applied to a custom-tailored moving picture education service that meets user's requirements.

1. A system for providing interactive moving picture contents, the system comprising:
an input tool for inputting and editing moving picture contents;
a moving picture contents server for providing a user with moving picture contents containing original moving picture data and related additional contents so that the user can view and edit the moving picture contents; and
a player for synthesizing a moving picture from an original moving picture and additional contents information transmitted from the moving picture contents server by using moving picture contents information containing the original moving picture data and the additional contents information, and for outputting the synthesized moving picture on a screen,
wherein the moving picture contents server comprises:
a database unit for storing membership information, moving picture information, and related additional contents information;
a data management unit for managing the database unit;
a contents transmitting/receiving unit for transmitting and receiving the moving picture contents information to and from the input tool and the player; and
a source providing unit for providing source data needed for editing the moving picture contents with the input tool.

2. The system as claimed in claim 1, wherein the input tool and the player are installed in a user's terminal connected to the moving picture contents server through the Internet.

3. The system as claimed in claim 1, wherein a moving picture contents screen provided to the user by the player displays, in an overlapping manner, a first layer where the original moving picture and a basic control menu are displayed; a second layer where a transparent mask representing an area of a relevant scene element of the original moving picture displayed on the first layer in relation with the scene element; and a third layer where an edit menu, a subtitle of the moving picture and an additional contents information window are arranged.

4. A system for providing interactive moving picture contents, the system comprising:
a user's terminal; and
a moving picture contents server connected to the user's terminal through the Internet so as to provide a user connected through the user's terminal with moving picture contents containing original moving picture data and related additional contents so that the user can view and edit the moving picture contents,
wherein the moving picture contents server comprises:
a database unit for storing membership information, moving picture information, and related additional contents information;
a data management unit for managing the database unit;
a contents providing unit for providing the user's terminal with moving picture contents synthesized in real time from a relevant original moving picture and additional contents information in response to a user's request; and
a contents editing unit for providing the user's terminal with an additional contents edit screen for newly or previously registered moving picture contents.

5. The system as claimed in claim 4, wherein a moving picture contents screen provided to the user's terminal by the contents providing unit displays, in an overlapping manner, a first layer where the original moving picture and a basic control menu are displayed; a second layer where a transparent mask representing an area of a relevant scene element of the original moving picture displayed on the first layer in relation with the scene element; and a third layer where an edit menu, a subtitle of the moving picture and an additional contents information window are arranged.

6. The system as claimed in claim 1 or 4, wherein the database unit comprises:
a member information DB for storing member's basic information including names, IDs, passwords, addresses and e-mail addresses of members;
a user's interest list DB for storing a list of moving pictures of interest according to each of the members;
a moving picture DB for storing the original moving picture data or information on a link to the original moving picture; and
an additional contents DB for storing the additional contents information corresponding to the original moving picture stored in the moving picture DB.

7. The system as claimed in claim 6, wherein the additional contents DB hierarchically stores basic additional information related to a scene element of the original moving picture stored in the moving picture DB, and subordinate addition information related to the basic additional information.

8. The system as claimed in claim 1 or 4, further comprising:
a payment server connected to the moving picture contents server so as to process a payment in response to a payment request from the moving picture contents server,
wherein the moving picture contents server further comprises:
a product transaction processing unit for receiving a product purchase request for a sales product contained in the additional contents from the user's terminal and processing the product purchase request.

9. A method of providing interactive moving picture contents to a user's terminal from a moving picture contents server, the method comprising:
a step of connecting, by a user, with the moving picture contents server through a terminal of the user;
a moving picture contents registering step of, if the user requests registration of new contents, providing the user's terminal with a moving picture contents registration screen, and receiving and storing playback information including a title, menu, and subtitle of a relevant original moving picture, together with original moving picture data or information on a link to the original moving picture;
a moving picture contents providing step of, if the user requests use of previously registered contents stored in the moving picture contents server, providing the user's terminal with moving picture contents synthesized from layers that are configured respectively with an original moving picture and related additional contents information of the requested moving picture contents; and
an additional contents editing step of, if the user requests editing additional contents for the new moving picture contents registered by the user or for the previously registered contents provided to the user, providing the user's terminal with an additional contents edit screen and storing additional contents edited by the user.

10. The method as claimed in claim 9, wherein the moving picture contents providing step comprises the steps of:
providing the user's terminal with user's interest list or a moving picture contents search window, and receiving a request for moving picture contents selected by the user among the previously registered moving picture contents;
synthesizing a series of moving picture contents screens from the layers that are configured respectively with an original moving picture, mask information and related additional contents information of the relevant moving picture contents, and successively outputting the synthesized moving picture contents screens to the user's terminal; and
if the user selects one of contents elements in the outputted moving picture contents screen and requests an information search, searching for additional contents information corresponding to the relevant contents element from a database unit, and outputting the searched additional contents information into an information window on the moving picture contents screen.

11. The method as claimed in claim 9, wherein the additional contents editing step comprises:
a contents type and output condition inputting step of receiving the type of additional contents to be edited and an output condition of the additional contents depending on the type of the additional contents from the user;
a contents component inputting step of receiving a selected contents component for configuring the additional contents from the user, and receiving relevant matters of the contents component from the user; and
a step of, if all contents components to be contained in the additional contents are completely edited, receiving the positions and sizes of the edited contents components from the user, and setting a layout of an information window with the additional contents outputted therein.

12. The method as claimed in claim 11, wherein in the contents component inputting step, the contents component is selected from a text, an image, a moving picture, a sound, a decoration object such as a character or a speech bubble, a purchase button, a user-defined menu, and an external link.

13. The method as claimed in claim 11, wherein if the type of additional contents inputted in the contents type and output condition inputting step is scene element-related contents cooperating with a scene element of the original moving picture, a step of providing the user with a mask information input screen and receiving mask information corresponding to the relevant scene element is further performed.

14. The method as claimed in claim 13, wherein the step of receiving the mask information comprises the steps of:
receiving a time period to which a mask is applied;
manually or automatically setting a mask area where the mask is created at predetermined time intervals, in response to a user's selection; and
creating mask area information for each of image frames corresponding to the entire time period to which the mask is applied, from the inputted information on the mask area for each of the predetermined time intervals.

15. The method as claimed in claim 14, wherein the step of receiving mask information further comprises the step of receiving an attribute of a relevant scene element classified into a character, a product, a background and music, and the position of a mask attribute icon representing the attribute of the relevant scene element, and
in the moving picture contents providing step, the mask attribute icon is displayed at the inputted position if the user places a mouse cursor on the set mask area.

16. The method as claimed in claim 11, wherein if the contents component inputted in the contents component input step is a purchase button, the additional contents editing step further comprises the steps of providing the user with a payment attribute input screen and receiving a selected payment method, and receiving product information of a product for which a payment is to be made and payment-related information from the user, and
if the user who has viewed the additional contents information of the moving picture contents requests purchase of a product contained in the additional contents, the moving picture contents providing step further comprises the step of providing a payment screen for the relevant product and performing a payment for the relevant product in accordance with the payment method selected by the user.

17. The method as claimed in claim 16, wherein the step of receiving the product information of the product for which the payment is to be made and the payment-related information is configured to receive a product category, product name, product code of the product for which the payment is to be made, thereby providing an environment in which the user who uses the moving picture contents can search for a desired product using the product category, the product name and the product code.
